(19) United States
(12) Patent Application Publication
(10) Pub. No.: US 2004/0069204 A1
(43) Pub. Date: Apr. 15, 2004

(54) Cat scratching deterrent

(76) Inventor: Terry M. Smith, Hooper, UT (US)

Correspondence Address: TERRY M. SMITH, 6173 WEST 5800 SOUTH, HOOPER, UT, 84315, US

(21) Appl. No.: 10/270,414

(22) Filed: Oct. 15, 2002

(51) Int. Cl. G08B 9/00

(52) U.S. Cl. 116/22 A

(57) ABSTRACT

A cat scratching deterrent including a self standing blower unit with nozzles that can be positioned near and aimed at an area containing household items to be protected against cat scratching and a housing with a canister to hold an aerosol can of pressurized air and a battery power source; and a lid for the canister having a motor and cam assembly driven by the motor, with an enlarged caning portion projecting from the lid to actuate a valve of the aerosol can to supply air to said nozzles through a flexible connector tube, when motion is detected by a motion detector mounted in the housing.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention relates to devices intended to prevent cats from scratching and damaging or destroying home furnishings.

### BRIEF SUMMARY OF THE INVENTION

Principal objects of the present invention are to provide a device that will prevent scratching of furniture, carpets and other furnishings found in homes. Apparently because of a need to sharpen their claws household cats frequently scratch and damage upholstered furniture, wooden furniture and carpets. Consequently, there is a need for means to prevent such damaging actions without injury to the animals.

It is another object of the invention to provide a device that will prevent, or at least discourage, cats from scratching and damaging home furnishings while doing so without any injury to the animals.

Devices have been proposed in the past for frightening animals to keep them from performing damage. For example, numerous devices have been proposed that will periodically create noises that will disturb and keep birds and animal pests from settling into an area where they will cause damage. U.S. Pat. Nos. 3,113,304, 3,633,560, 4,745,859, 5,257,012 each show devices to periodically make noises to scare away birds and animals and that use a form of timer to set off the noises.

U.S. Pat. Nos. 4,573,427 and 4,598,660 disclose noise making devices for scaring birds where the noise making components are actuated by birds perching on an actuator structure.

U.S. Pat. Nos. 3,831,548 and 5,224,438 disclose devices to create vibrations and noise to scare off rodents.

U.S. Pat. No. 5,009,192 discloses an apparatus for deterring animals from intruding into gardens, fields, yards, etc. that turns on a water sprinkler to sprinkle an area in response to sensing of an animal in the area by an infrared proximity sensor. Water flow through the sensor is continued so long as the sensor is actuated. A switch turns “on” when an animal; is sensed and “off” when an animal is no longer sensed. The control valve is connected to a hose which is connected to a pressurized water source, The valve is powered by a rechargeable battery. While somewhat portable the device is restricted to use where a supply of pressurized water is available.

Principal features of the invention include a fully portable apparatus that will shoot puffs of air at a cat moving into the vicinity of a known past or suspected future scratching location. The device can be set in almost any location in a house and when a cat is detected by a motion detector sensor component a motor is operated to turn a cam that will activate the nozzle of a can of compressed air and to admit at least one puff of air through a nozzle or a plurality of nozzles aimed at the area covered by the detector.

Additional objects and features of the invention will become apparent to those skilled in the art to which the invention pertains from the following detailed description and drawings.

### BRIEF DESCRIPTION OF THE SEVERAL VIEWS OF THE DRAWINGS

FIG. 1 is a perspective view of the cat scratching deterrent of the invention; and

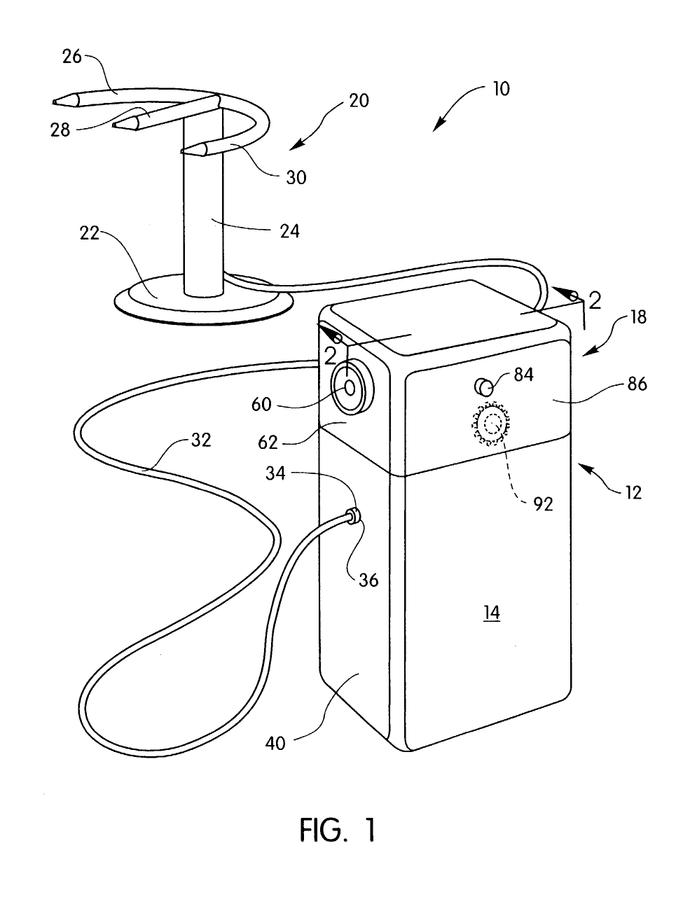

FIG. 2, a vertical section, taken on the line 2-2 of FIG. 1.

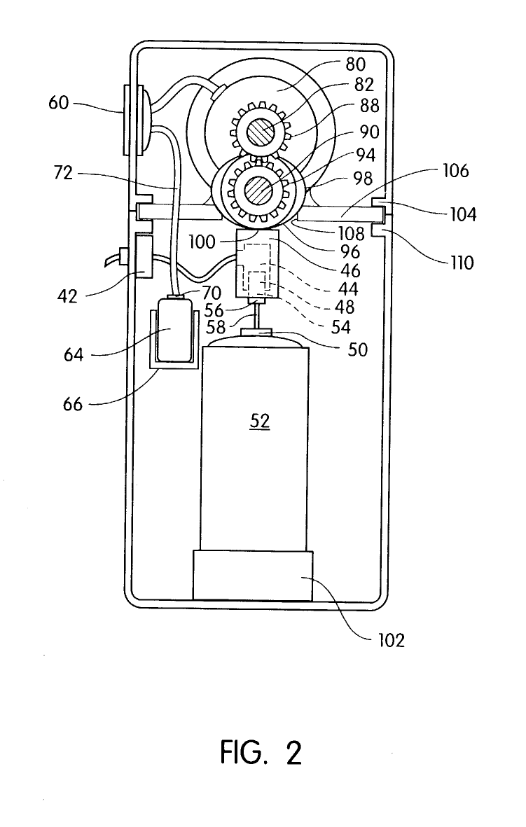

### DETAILED DESCRIPTION OF THE INVENTION

Referring now to the drawings:

In the illustrated preferred embodiment, the cat scratching deterrent of the invention is shown generally at 10. Cat scratching deterrent 10 includes a housing 12 with a lower canister 14 and a lid 18.

A blower 20 includes a weighted base 22, a hollow sleeve 24 projecting upwardly from the base and a plurality of flexible nozzles 26, 28 and 30. A flexible tube 32 connects the interior of the hollow sleeve 24 through a grommet 34 in a hole 36 through a wall 40 of the canister 14. The tube 32 extends through a grommet 42 on the inside of wall 40 and into a passage 44 through an end cap 46

End cap 46 telescopes over the upper end 48 of control valve 50 for an air filled aerosol can 52. Passage 44 through the end cap fits snugly over a discharge end 54 of the control valve 50 and rests on a stop 56 mounted on the actuator stem 58 of the valve 50. As is well known, depression of the actuator stem 58 will allow air flow through the valve 50, discharge end 54, passage 44, flexible tube 32, sleeve 24 and nozzles 26, 28 and 30. The nozzles are made of a plastic material that can be bent to change the directional flow of the discharged air and that will retain the bent shape until changed.

A motion detector 60 is mounted in a sidewall 62 of the lid 18, Power to the motion detector is provided by a battery 64 positioned in a battery holder 66 that is mounted to a wall 68 of the canister 14, A battery connector 70 connects to the terminals of the battery and wires 72 electrically interconnect the battery connector and the motion detector. Wires 72 interconnect motion detector 60 to an electric motor 80 mounted in and carried by the lid 18.

The output shaft 82 of motor 80 is journaled at 84 in a wall 86 of lid 18 and a gear 88 is fixed to and rotates with shaft 82. Another shaft 90 has one end journaled in 86 of lid 18 and a reduction gear 92 is rotates with shaft 90.

A cam 96 is fixed to the shaft 90 and rotates with the shaft 90 and the gear 92. Cam 96 has an enlarged camming surface 98 that will engage a top surface 100 of end cap 46 to depress the end cap and open valve 50, as will be further explained.

An upstanding ring 102 formed inside canister receives a bottom of aerosol can 52 to hold the aerosol can in place within the canister 14.

A shoulder 104 inside lid 18 provides a backing ring for a plate 106, extending across the canister engaging end of the lid. The plate 106 is frictionally secured in the lid. A slot 108 formed in the plate 106 allows the camming surface 98 to project into the canister and to engage the top surface 100 of end cap 46.

The side walls of lid 18 extend beyond the plate 106 to engage a lip 110 on the inside of the walls of the canister 18 and the upper ends of the canister walls.

In operation, a user will remove lid 18 from canister 14 to insert the battery 64 in battery holder 66 and connect the battery to wires 72. The user will also insert the base of an aerosol can 52 in the ring 102. Lid 18 is replaced so that the cam 96 engages or is positioned just above the top surface 100 of the end cap 46 and the cat scratching deterrent 10 is ready for use. Housing 12 and blower 20 are positioned upright in the vicinity of household items, i.e. carpet, rug, sofa, table, etc. to be protected. The nozzles 26, 28 and 30 are directed towards the area to be protected and may be bent, if desired, to provide better coverage of the area.

When a cat moves into the area to be protected, movement is detected by the motion detector 60 and a circuit is completed through the battery 64, wires 72, the motion detector 60 to energize motor 80. Energizing of the motor turns the output shaft 82 of the motor and gear 88, fixed thereto. Gear 88 turns gear 94 and the shaft 90 to which gear 94 is secured. Rotation of shaft 90 turns cam 96 affixed thereto. During the time the time that the enlarged camming surface 98 is engaged with the top surface 100 of end cap 46 the valve 50 is opened to allow air from the aerosol can 52 to be direcrewd through the nozzles 26, 28 and 30. It is expected that the puff of air emitted through the nozzles will frighten the cat away from the area being protected. Should the cat remain in the protected area motion will repeatedly activate the motion detector 60 and to repeatedly direct air towards the cat.

The cat scratching deterrent 10 is easily moved from location to location, as my be necessary to protection of household items.

Although a preferred embodiment of the invention has been herein disclosed, it is to be understood that such disclosure is by way of example and that other variations are possible without departing from the subject matter coming within the scope of the following claims, which subject matter we regard as our invention.

1. A cat scratching deterrent comprising
a blower including at least one nozzle;
a source of pressurized air;
conduit means connecting each said nozzle to said source of pressurized air;
a motion detector; and
circuit means including a battery and said motion detector for actuating said source of pressurized air to provide a limited amount of air from said source of pressurized air and said conduit means upon actuation of said motion detector.

2. A cat scratching deterrent zs in claim 1, wherein
the source of compressed air is an aerosol can containing air under pressure.

3. A cat scratching deterrent as in claim 2, wherein
each said nozzle extends from a hollow tube; and
said hollow tube extends from a weighted base.

4. A cat scratching deterrent as in claim 3, wherein said means for actuating said aerosol can comprises;
a motor actuated by said circuit means in respnse to motion detected by the motion detector and having an output shaft;
a cam having an enlarged camming portion thereon a valve having a valve actuator controlling flow from said aerosol can; and
positioning means for positioning said cam and said valve for said valve to be opened by engagement of said enlarged camming portion with said actuator of said valve.

5. A cat scratching deterrent, as in claim 4, wherein the positioning means comprises
a canister having means therein to position the battery and the aerosol can; and
a lid closing said canister can, said lid having the motor and a cam shaft mounted therein and including means to rotate said cam shaft upon energizing of said motor with the enlarged camming portion of the cam projecting from the lid to engage the valve actuator during rotation of the output shaft of the motor.

6. A cat scratching deterrent as in claim 5 including a plurality of nozzles.

7. A cat scratching deterrent as in claim 6, wherein at least one of said nozzles is bendable to change the direction of air flow therefrom.
